(19) United States
(12) Patent Application Publication
(10) Pub. No.: US 2022/0012539 A1
(43) Pub. Date: Jan. 13, 2022

(54) EVALUATING DEVICE, PLANT CONTROL ASSIST SYSTEM, EVALUATION METHOD, AND PROGRAM

(71) Applicant: MITSUBISHI HEAVY INDUSTRIES, LTD., Tokyo (JP)

(72) Inventors: Kenji TAKAO, Tokyo (JP); Yusuke YAMASHINA, Tokyo (JP)

(21) Appl. No.: 17/212,359

(22) Filed: Mar. 25, 2021

(30) Foreign Application Priority Data
Jul. 8, 2020 (JP) 2020-117529

(51) Int. Cl. G06K 9/62; G06N 3/08; G05B 19/418

(52) U.S. Cl. CPC G06K 9/6262; G05B 19/4183; G06N 3/08

(57) ABSTRACT

An evaluating device includes a first acquisition unit configured to acquire a first index, a second acquisition unit configured to acquire a second index, and an evaluating unit configured to evaluate reliability. The first index indicates the difference between learning input data and actual operation input data in data space. The second index indicates the difference in the ignition tendency of the neurons between the time of input of the learning input data in the learning model of the neural network and the time of input of the actual operation input data in the learning model of the neural network. The evaluating unit evaluates the reliability of the prediction value output from the learning model with respect to the actual operation input data based on the first index acquired by the first acquisition unit and the second index acquired by the second acquisition unit.

### CROSS-REFERENCE TO RELATED APPLICATIONS

This application claims the benefit of priority to Japanese Patent Application Number 2020-117529 filed on Jul. 8, 2020. The entire contents of the above-identified application are hereby incorporated by reference.

### TECHNICAL FIELD

The present disclosure relates to an evaluating device, a plant control assist system, an evaluation method, and a program.

### RELATED ART

In recent years, a learning device configured to predict input data using a neural network model and a method of evaluating the learning device have been developed. For example, in JP 2006-236367, a method is described in which the reliability of an output value (prediction value) of the neural network is evaluated. In this method, the similarity between an item for evaluation (actual operation input data) and a learning item (learning input data) is determined based on Euclidean distance and weighting based on the degree of importance of an input factor (input data) is applied to the calculation to obtain an evaluation score.

### SUMMARY

In a case where the learning model of the neural network is used in the actual operation, a neuron that did not ignite during learning may ignite when the actual operation input data outside of the learning input data is input. When the prediction value obtained in this state is used, unintended behavior may occur, and the prediction accuracy may be decreased. Therefore, in such a case, the reliability should be evaluated to be low.

However, the evaluation method of JP 2006-236367 is not designed for such an evaluation. In order to improve the evaluation accuracy, it is desirable to evaluate on the basis of differences in the ignition tendencies of the neurons in cases when the learning input data is input and in cases when the actual operation input data is input.

In light of the foregoing, the present disclosure is directed at improving the evaluation accuracy when evaluating the reliability of a prediction value output from the learning model of a neural network.

An evaluating device according to the present disclosure includes:

a first acquisition unit configured to acquire a first index indicating a difference in data space between learning input data and actual operation input data;

a second acquisition unit configured to acquire a second index indicating a difference in ignition tendency of neurons between a case when the learning input data is input in a learning model of a neural network and a case when the actual operation input data is input in the learning model of the neural network; and

an evaluating unit configured to evaluate a reliability of a prediction value output from the learning model with respect to the actual operation input data based on the first index and the second index.

A plant control assist system according to the present disclosure includes:

a learning device including a learning model for predicting a state of a plant; and

a parameter adjustment device configured to adjust a setting parameter and/or an operation target value of a control device of the plant according to a prediction result of the learning model,

the learning device being configured to execute re-learning of the learning model according to an evaluation result of the evaluating device described above.

An evaluation method according to the present disclosure includes:

acquiring a first index indicating a difference in data space between learning input data and actual operation input data;

acquiring a second index indicating a difference in ignition tendency of neurons between a case when the learning input data is input in a learning model of a neural network and a case when the actual operation input data is input in the learning model of the neural network; and

evaluating a reliability of a prediction value output from the learning model with respect to the actual operation input data based on the first index and the second index.

A program according to the present disclosure causes a computer to execute:

acquiring a first index indicating a difference in data space between learning input data and actual operation input data;

acquiring a second index indicating a difference in ignition tendency of neurons between a case when the learning input data is input in a learning model of a neural network and a case when the actual operation input data is input in the learning model of the neural network; and

evaluating a reliability of a prediction value output from the learning model with respect to the actual operation input data based on the first index and the second index.

According to the present disclosure, it is possible to improve the evaluation accuracy when evaluating the reliability of the prediction value output from the learning model of the neural network.

### BRIEF DESCRIPTION OF DRAWINGS

The disclosure will be described with reference to the accompanying drawings, wherein like numbers reference like elements.

FIG. 1 is a block diagram schematically illustrating the configuration of an evaluating device according to an embodiment.

FIG. 2A is a schematic diagram illustrating an example of a first index acquired on the basis of the Euclidean distance by the evaluating device according to an embodiment.

FIG. 2B is a schematic diagram illustrating an example of the first index acquired on the basis of the dropout method by the evaluating device according to an embodiment.

FIG. 3 is a conceptual diagram illustrating an example of a method of calculating a neuron coverage used by the evaluating device according to an embodiment.

FIG. 4 corresponds to FIG. 3 and is a conceptual diagram illustrating an example of the calculation result of the neuron coverage in one neuron.

FIG. 5 is a conceptual diagram illustrating an example of a method of calculating a neuron coverage used by the evaluating device according to an embodiment.

FIG. 6 is a conceptual diagram illustrating an example of a method of calculating a neuron pattern used by the evaluating device according to an embodiment.

FIG. 7 is a conceptual diagram illustrating an example of the second index acquired on the basis of the neuron ignition pattern by the evaluating device according to an embodiment.

FIG. 8 is a conceptual diagram illustrating an example of the second index acquired on the basis of the neuron ignition frequency by the evaluating device according to an embodiment.

FIG. 9 is a flowchart for describing an example of the processing executed by the evaluating device according to an embodiment.

FIG. 10 is a block diagram schematically illustrating the configuration of a plant control assist system according to an embodiment.

### DESCRIPTION OF EMBODIMENTS

An embodiment will be described hereinafter with reference to the appended drawings. However, dimensions, materials, shapes, relative positions and the like of components described in the embodiments or illustrated in the drawings shall be interpreted as illustrative only and not intended to limit the scope of the invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance within a range in which it is possible to achieve the same function.

For instance, an expression of an equal state such as “same”, “equal”, “uniform” and the like shall not be construed as indicating only the state in which the feature is strictly equal, but also includes a state in which there is a tolerance or a difference within a range where it is possible to achieve the same function.

Further, for instance, an expression of a shape such as a rectangular shape, a cylindrical shape or the like shall not be construed as only the geometrically strict shape, but also includes a shape with unevenness, chamfered corners or the like within the range in which the same effect can be achieved.

On the other hand, an expression such as “comprise”, “include”, “have”, “contain” and “constitute” of one constituent element are not intended to be exclusive of other constituent elements.

### Configuration of Evaluating Device

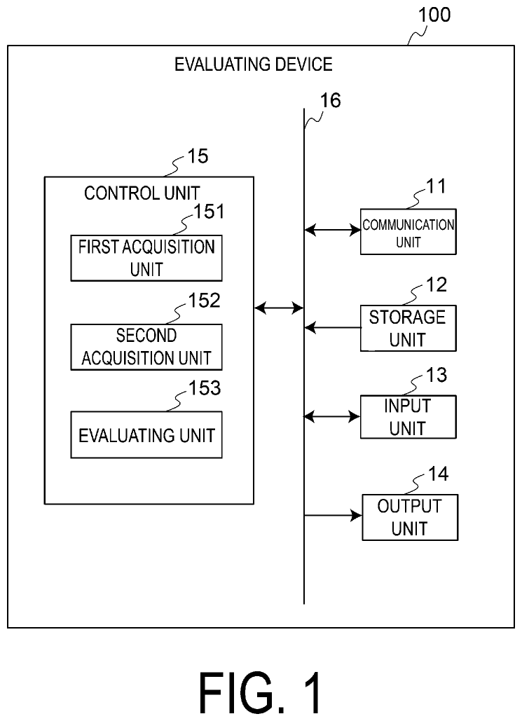

The configuration of an evaluating device 100 according to an embodiment is described below. The evaluating device 100 is a device used to evaluate the reliability of the prediction value output by a learning model of a neural network with respect to actual operation input data. The neural network may be a convolutional neural network (CNN) or a recurrent neural network (RNN). The neural network may also be a Long Short-Term Memory (LSTM) network using values indicative of neuronal cell conditions. FIG. 1 is a block diagram schematically illustrating the configuration of the evaluating device 100 according to an embodiment.

As illustrated in FIG. 1, the evaluating device 100 includes a communication unit 11 configured to communicate with another device, a storage unit 12 configured to store various types of data, an input unit 13 configured to accept user input, an output unit 14 configured to output various types of information, and a control unit 15 configured to control the overall device. These constituent elements are connected to each other by a bus line 16.

The communication unit 11 is a communication interface including a Network Interface Card controller (NIC) for performing wired communication or wireless communication. The communication unit 11 communicates with another device (for example, a learning device 200 including a learning model).

The storage unit 12 includes, for example, a random access memory (RAM), a read only memory (ROM), and the like. The storage unit 12 stores a program for executing various control processes (for example, a program for evaluating reliability) and various types of data (for example, calculation formula for a first index and a second index, evaluation results, and the like).

Note that the evaluating device 100 may be a separate device from the learning device 200 including the learning model or may be integrally formed therewith. When the two are separate devices, the evaluating device 100 communicates with the learning device 200 via the communication unit 11 to evaluate the reliability and adjust the structure of the neural network. When the two are integrally formed, the evaluating device 100 (the learning device 200) evaluates the reliability of the prediction value output from the learning model stored in the storage unit 12 and adjusts the structure of the neural network.

The input unit 13 is, for example, constituted by an input device, such as an operation button, a keyboard, a pointing device, or the like. The input unit 13 is an input interface used by a user to input instructions.

The output unit 14 is, for example, constituted by an output device, such as a Liquid Crystal Display (LCD), an Electroluminescence (EL) display, a speaker, or the like. The output unit 14 is an output interface for presenting various types of information (for example, a notification prompting for re-learning, an evaluation result, and the like) to the user.

The control unit 15 is constituted by a processor, such as a Central Processing Unit (CPU), a Graphics Processing Unit (GPU), and the like. The control unit 15 controls the operations of the entire device by executing a program stored in the storage unit 12.

The functional configuration of the control unit 15 will be described below. The control unit 15 functions as the first acquisition unit 151, a second acquisition unit 152, and an evaluating unit 153.

A first acquisition unit 151 is configured to acquire the first index indicating the difference between the learning input data and the actual operation input data in the data space. The learning input data is input data (explanatory variables) in the learning phase. The learning input data may be previous performance data obtained from a database. The actual operation input data is input data (explanatory variables) in the operation phase after the learning model has been applied for actual operation. The actual operation input data may be measurement data acquired in real-time from a sensor or the like.

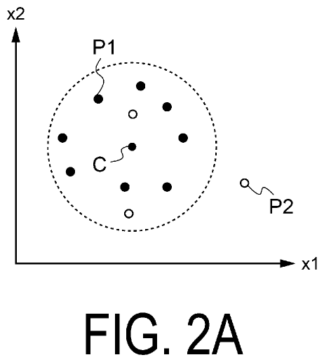

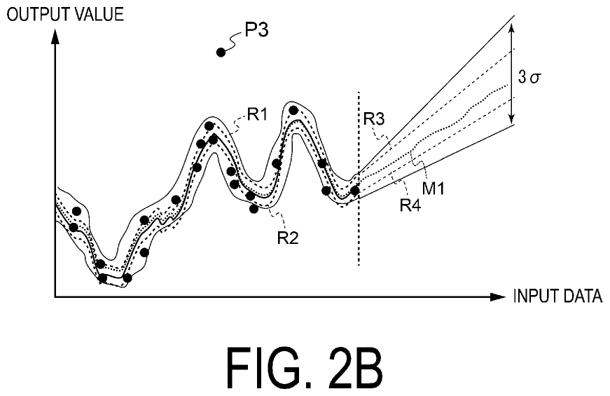

In some embodiments, the first acquisition unit 151 is configured to calculate the first index on the basis of the Euclidean distance in the data space between the learning input data and the actual operation input data. FIG. 2A is a schematic diagram illustrating an example of the first index acquired on the basis of the Euclidean distance by the evaluating device 100 according to an embodiment.

This diagram illustrates an example of calculating a two dimensional Euclidean distance in a case where two variables, x1 and x2, constituting the input data are represented by the horizontal axis and the vertical axis, respectively. A black plot P1 indicates the learning input data and a white plot P2 indicates the actual operation input data. The first acquisition unit 151 may calculate the first index using the distances of the plurality of actual operation input data P2 by using, as a reference point, any one of the plurality of plots P1, which are learning input data, or may calculate the first index using the Euclidean distance of each of the plurality of plots P2 by using, as a reference point, a center value C of the distribution of the plurality of plots P1.

Additionally, the first acquisition unit 151 may calculate the overall centroid of the plurality of plots P1, which are learning input data, and the overall centroid of the plurality of plots 2 of the actual operation input data, and calculate the first index using the Euclidean distance of the two. The first acquisition unit 151 may identify the learning input data closest to the input value of the actual operation input data by a technique such as the k-nearest neighbors algorithm, and calculate the first index using the Euclidean distance of the two. Note that the first acquisition unit 151 may calculate the Euclidean distance of three or more dimensions using more of the input data to acquire the first index. The first acquisition unit 151 may calculate the Euclidean distance excluding the outliers of the plots P1, P2 to obtain the first index.

In some embodiments, the learning input data and the actual operation input data each include a plurality of types of input data, and the first acquisition unit 151 is configured to calculate the first index by adding weighting based on the degree of importance to each type of input data of the learning input data and the actual operation input data. Weighting may be performed by multiplying each type of input data by a unique degree of importance as described in JP 2006-236367. The calculation of the degree of importance may be performed using the mathematical formula described in JP 2006-236367.

In some embodiments, the first acquisition unit 151 is configured to represent, as a probability distribution, the coefficient of dropout of the output value in a case where the learning input data is input and calculate the first index on the basis of the position of the actual operation input data in the probability distribution. FIG. 2B is a schematic diagram illustrating an example of the first index acquired on the basis of the dropout method by the evaluating device 100 according to an embodiment. In the graph of FIG. 2B, the horizontal axis represents a variable that constitutes the input data. The vertical axis represents the output value (prediction value).

In the dropout method, neurons that constitute the neural network are probabilistically selected to be dropped out (given zero weighting or not used). Weighting is applied by performing learning with learning input data in a dropped out state. While maintaining that weighting, the dropout is returned, and the weighting is then applied by performing learning using the learning input data again with the probabilistically selected neurons in a dropped out state. Such processes are repeated. In such processes, the variation of the prediction values output from the learning model is evaluated. As illustrated in FIG. 2B, the variation is indicated by the average line M1 indicating the average of the prediction values and the band indicating the width of variance, i.e., the variance value, (for example, 3σ) from the average line M1. A plot P3 indicates the data obtained in the learning. If the post-hoc distribution of the plot P3 (the band indicated by curves R1, R2) is determined, it is also possible to estimate the distribution (curves R3, R4 bands) of the regions where there is no data obtained in learning. The first index can be calculated on the basis of the band indicating the variance value in the case where the actual operation input data is input. For example, it can be seen that the variance value 3σ increases as shown in a region where the plot P3 is not present on the right side of the dotted line in a case where the actual operation input data deviates from the learning input data. This indicates an increase in uncertainty. On the other hand, it can be seen that the variance value 3σ decreases as shown in a region where the plot P3 is present on the left side of the dotted line in a case where the actual operation input data is close to the learning input data.

A second acquisition unit 152 is configured to acquire the second index indicating the difference in the ignition tendency of the neurons between the time of input of the learning input data in the learning model of the neural network and the time of input of the actual operation input data in the learning model of the neural network. The ignition tendency of the neurons may be an index based on the degree of neuronal ignition (neuron coverage or neuron patterns) or may be an index based on the ignition frequency of the neurons.

In some embodiments, the second acquisition unit 152 is configured to calculate the second index based on the neuron coverage indicating the degree of ignition of the entire plurality of neurons included in the neural network. The degree of ignition of neurons means coverage such that an output value φ of neurons, rather than being close to one, is evenly output from multiple neurons. Note that although some papers define ignition as the magnitude of the output value of a neuron exceeding a threshold value, the present disclosure defines ignition as output being evenly output.

In some embodiments, the second acquisition unit 152 is configured to calculate the second index on the basis of one or more of a degree of ignition in each of the plurality of neurons included in the neural network, a degree of ignition of the neurons in a layer of the neural network model including a plurality of layers, or a degree of diversity of ignition patterns of the plurality of neurons.

The method of calculating the neuron coverage may include calculating for each neuron and calculating for each layer of the multiple layers of the neural network. These calculation methods will be described below.

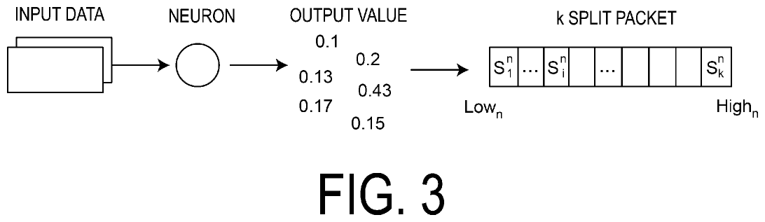

First, as an example of calculating for each neuron, k-Multisection Neuron Coverage (KMN) is described. FIG. 3 is a conceptual diagram illustrating an example of a method of calculating a neuron coverage used by the evaluating device 100 according to an embodiment.

As illustrated in FIG. 3, first, multiple input data x are input in one neuron n, and a plurality of output values φ (x, n) are obtained. x (because x is a vector, is it written in bold, the same applies below) is represented by a collection of data extracted from a data set T for calculating the coverage. The data set T may be learning input data or may be actual operation input data.

A maximum value Highₙ and a minimum value Lowₙ of output value φ (x, n) output from the neuron n are obtained. Here, the numerical range from the minimum value Lowₙ to the maximum value Highₙ (Lowₙ≤φ (x, n)≤Highₙ) is divided into k number of regions (split packets S).

The number of divisions k may be set to any value by the user. The subscripts (1 . . . i . . . k) below the split packets S indicate the ordinal number of the split packets S. The subscript n above the split packets S indicate the nth neuron of the plurality of neurons. Next, for all of the plurality of input data x, how much the output value φ (x, n) of the neuron n covers the k number of split packets is determined.

For example, a neuron coverage Cov in one neuron can be calculated using the following Formula (1). In Formula (1), the numerator indicates the number of split packets S to which a plurality of output values φ (x, n) belong, and the denominator is the number of divisions k.

$$Cov = \frac{\vert \{ {S}_{i}^{n} \vert ∃ x ∈ T \text{:} ϕ ( x , n ) ∈ {S}_{i}^{n} \vert}{k} . \qquad ( 1 )$$

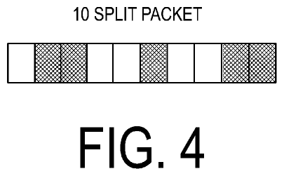

FIG. 4 corresponds to FIG. 3 and is a conceptual diagram illustrating an example of the calculation result of the neuron coverage in one neuron n. For example, let's assume that the number of divisions k=10, the maximum value Highₙ=1, and the minimum value Lowₙ=0. In this case, it is assumed that the output values φ (x, n) in a case where a plurality of input data x is input to the neuron n are the following seven values: 0.11, 0.15, 0.23, 0.51, 0.88, 0.92, and 0.96.

Then, as indicated by the hatching in FIG. 4, the second, third, sixth, ninth, and tenth split packets S of the ten split packets S are covered. In this case, the neuron coverage Cov is 0.5 (half of one neuron n ignites). Note that the neuron coverage basically increases when the amount of input data is large. However, even if the input data is increased due to the bias in the input data, the neuron coverage is often saturated without becoming 1.

Such calculations may be extended to determine the coverage in a case where the data set T is input to all neurons N, in other words, a neuron coverage KMNCov for the entire neural network. For example, the neuron coverage KMNCov for the entire neural network can be calculated using the following Formula (2).

$$KMNCov ( T , k ) = \frac{{\sum }_{n ∈ N} \vert \{ {S}_{i}^{n} \vert ∃ x ∈ T \text{:} ϕ ( x , n ) ∈ {S}_{i}^{n} \vert}{k \times \vert N \vert} \qquad ( 2 )$$

In Formula (2), the numerator is a value obtained by summing the number of split packets S to which the plurality of output values φ (x, n) of the neurons n belong to by the total neurons N, and the denominator is the product of the number of divisions k and the number of neurons n included in the total neurons N. Note that this approach focuses on how much the output values φ (x, n) cover the k number of split packets S.

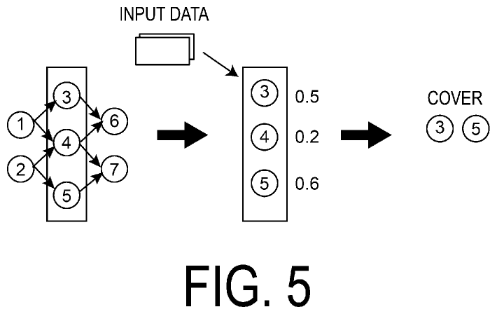

Next, as an example of calculating for each layer of a multiple layer neural network, a Top-k Neuron Coverage (TKN coverage) will be described. FIG. 5 is a conceptual diagram illustrating an example of a method of calculating a neuron coverage used by the evaluating device 100 according to an embodiment.

First, in a case where multiple input data x is input to a layer, k number of neurons with a higher degree of ignition are extracted from all of the neurons N. The number k of extracted neurons may be set to any value by the user.

In the example illustrated in FIG. 5, the neural network includes three layers of seven neurons numbered 1 to 7. Here, a plurality of input data x is input to the three neurons, third to fifth, in the two layers, and output values φ (x, n) for each neuron are obtained. The output value φ (x, n) for the third is 0.5, for the fourth is 0.2, and for the fifth is 0.6. In a case where k=2, the third and fifth neurons are selected because the top two are extracted. What percentage to select is determined in a case where these selected neurons are input in the data set T (a collection of input data including multiple input data x). Another data is also input to check multiple times which neurons are chosen to be two higher neurons. Finally, it is preferable that the probability of selecting the upper two is such that the probability is equal for the three neurons, the third to the fifth, for the second layer. Such calculations are also performed on other layers. In other words, in this method, the neuron coverage is evaluated on the basis of the degree of evenness indicating whether the probability of each neuron being selected in each layer is even.

For example, a neuron coverage TKNCov in one layer can be calculated using the following Formula (3). In Formula (3), 1 is the number of layers (layers) of the neural network, and i represents the ith layer of the layers.

$$TKNCov ( T , k ) = \frac{\vert {⋃}_{x ∈ T} ( {⋃}_{1 \leq i \leq l} {top}_{k} ( x , i ) ) \vert}{\vert N \vert} . \qquad ( 3 )$$

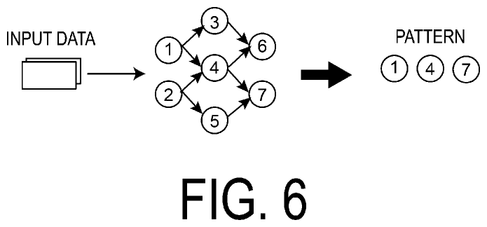

Next, a method of calculating a neuron pattern will be described. Specifically, a case in which a Top-k Neuron Pattern (neuron pattern TKNPat) in a neural networks of multiple layers is calculated will be described. FIG. 6 is a conceptual diagram illustrating an example of a method of calculating a neuron pattern used by the evaluating device 100 according to an embodiment.

As illustrated in FIG. 6, first, multiple input data x are input in all of the neurons N, and a plurality of output values φ (x, n) are obtained. x represents a collection of data extracted from the data set T to calculate the coverage. Here, the k number of upper neurons of the degree of ignition are extracted from each layer. The number k of extracted neurons may be set to any value by the user. By extracting these neurons, a neuron pattern is obtained.

For example, in the example illustrated in FIG. 6, k=1, and based on the magnitude of the output value φ (x, n), the first neuron is extracted from the first layer is extracted, the fourth neuron is extracted from the second layer, and the seventh neuron is extracted from the third layer. In this case, the neuron pattern is 1, 4, 7. The neuron pattern is determined for all input data x. In other words, another data is also input to check multiple times which neurons have been extracted. Finally, it is preferable that the probability of being extracted is equal for all neurons. In other words, in this method, the neuron coverage is evaluated on the basis of the degree of evenness indicating whether the probability of being extracted is even for each neuron.

For example, the neuron pattern TKNPat can be calculated using the following formula (4). In Formula (4), 1 is the number of layers of the neural network.

TKNPat(T,k)=|{(topₖ(x,1), . . . ,topₖ(x,l))|x∈T}|. (4)

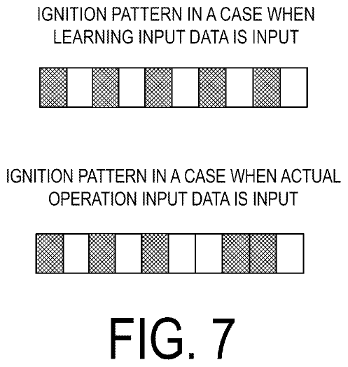

In some embodiments, the second acquisition unit 152 is configured to calculate the second index based on the difference in neuron coverage indicating the degree of ignition of the entire plurality of neurons and the difference in the ignition patterns of the plurality of neurons. FIG. 7 is a conceptual diagram illustrating an example of the second index acquired on the basis of the neuron ignition pattern by the evaluating device 100 according to an embodiment.

FIG. 7 illustrates an example of an ignition pattern in a case where there are ten neurons in the neural network. Neurons ignited with data input are indicated by hatching. For example, the ignition pattern in a case where learning input data is input indicates that the first, third, fifth, seventh, and ninth neurons from the left were ignited. In this case, the neuron coverage is 50%. On the other hand, the ignition pattern in a case where actual operation input data is input indicates that the first, third, fifth, eighth, and ninth neurons from the left were ignited. In this case, the neuron coverage is 50%. The difference between these neuron coverages is 0%.

On the other hand, when comparing the ignition pattern between the case when the learning input data is input and the case when the actual operation input data is input, the ignition states of the seventh and eighth positions from the left are different. In the case when the learning input data is input, the seventh neuron is ignited, whereas in the case when the actual operation input data is ignited, the seventh neuron is not ignited. In the case when the learning input data is input, the eight neuron is not ignited, whereas in the case when the actual operation input data is ignited, the eighth neuron is ignited. In this case, the ignition state of two neurons of the ten neurons is changed, so the difference in ignition pattern is 20%.

In some embodiments, the second index is calculated considering these two differences. For example, the second index may be a sum of two differences (0%+20%=20%) or may be a linear combination of the two differences (0%×coefficient A+20%×coefficient B=20%×coefficient B). The second index may be a product of the two differences. Note that, however, that if any one of the two differences is zero, then the second index, which is the product, is zero.

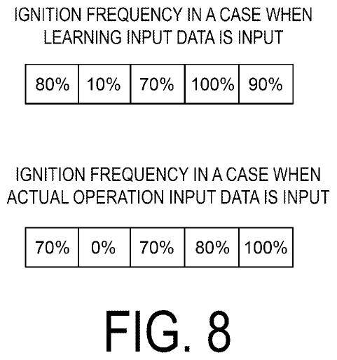

In some embodiments, the second acquisition unit 152 is configured to calculate the second index based on the difference in ignition frequency between the plurality of neurons. FIG. 8 is a conceptual diagram illustrating an example of the second index acquired on the basis of the neuron ignition frequency by the evaluating device 100 according to an embodiment.

FIG. 8 illustrates an example of an ignition frequency of the neurons in a case where there are five neurons in the neural network. For example, when the number of ignitions in a case where ten input data is input is seven, the ignition frequency is 70%. In the illustrated example, the ignition frequency of each neuron in a case where the learning input data is input is 80%, 10%, 70%, 100%, and 90% from the left. Note that in this case, the neuron coverage is 100%. The ignition frequency of each neuron in a case where the actual operation input data is input is 70%, 0%, 70%, 80%, and 100% from the left. Note that in this case, the neuron coverage is 80%.

Here, the rate of change of the ignition frequency of each neuron may be calculated, and the sum may be the second index. In a case where the ignition frequency for the learning input data and the ignition frequency for the actual operation input data are not both 0%, the rate of change of the ignition frequency is calculated from the formula: rate of change of ignition frequency=ignition frequency for learning input data−ignition frequency for actual operation input data/ignition frequency for learning input data. In the illustrated example, the rate of change in ignition frequency is 0.12, 1, 0, 0.2, 0.11 from the left. In this case, the second index is 1.43.

If one of either the ignition frequency for the learning input data or the ignition frequency for the actual operation input data is 0%, the rate of change of the ignition frequency may be the other ignition frequency (in other words, the denominator is considered to be 1 in the above formula). In a case where both the ignition frequency for the learning input data and the ignition frequency for the actual operation input data are 0%, the rate of change in the ignition frequency may be 0. This may clear computational constraints. Note that the calculation formula for the second index can be changed as appropriate. For example, the rate of change of the ignition frequency may be divided by the number of neurons, and this normalized value may be the second index.

The evaluating unit 153 is configured to evaluate the reliability of the prediction value output from the learning model with respect to the actual operation input data on the basis of the first index acquired by the first acquisition unit 151 and the second index acquired by the second acquisition unit 152. This evaluation may be performed by comparison of the first threshold value and the second threshold value.

In some embodiments, the evaluating unit 153 is configured to determine a center value of the distribution in the data space of the learning input data, set the deviation or variance value from the center value as the first threshold value for the acceptability determination of the first index, and evaluate reliability. For example, as illustrated in FIG. 2A, the center value C may be determined from the distribution of the learning input data, and the first threshold value may be a constant distance from the center value C as indicated by the dotted line. Furthermore, the variance may be determined from the distribution of the learning input data, and 2σ or 3σ may be the first threshold value, for example. In the above-described weighting, the first threshold value is set with respect to the first index, which is the value calculated using the weighting coefficient. In the case of the dropout method, the first threshold value is set with respect to a variance value (for example, 3σ) in a case where the actual operation input data is input and dropped out.

Note that the method for setting the first threshold value is not limited to these. For example, any one or more (outliers) separated from the center value C of the plurality of plots P1 may be the first threshold value. A constant value set to determine whether or not the distance between each of the plurality of plots P1 and the plurality of plots P2 exceeds a constant value may be the first threshold value.

In some embodiments, the evaluating unit 153 is configured to evaluate the reliability with the second threshold value for the acceptability determination of the second index being the increase in width corresponding to the neuron coverage in a case where the learning input data is input. For example, in a case where the learning input data is input and the neuron coverage is greater than or equal to 80% (for example, 80%), a value obtained by adding an increase in width of 2% or greater (for example, 82%) may be used as the first threshold value. In a case where the learning input data is input and the neuron coverage is equal to or greater than 60% and less than 80% (for example, 70%), a value obtained by adding an increase in width of 5% or greater (for example, 75%) may be used as the first threshold value. In a case where the learning input data is input and the neuron coverage is less than 60% (for example, 50%), a value obtained by adding an increase in width of 10% or greater (for example, 60%) may be used as the first threshold value.

In this manner, in a case where the learning input data is input and the neuron coverage is a first value, the increase in width as the second threshold value may be set to a first increase in width, and in a case where the learning input data is input and the neuron coverage is a second value that is less than the first value, the increase in width as the second threshold value may be set to a second increase in width greater than the first increase in width.

In a case where the neuron coverage when learning is large, even a small change in the neuron coverage during actual operation may have a large affect. In a case where the neuron coverage when learning is small, a small change in the neuron coverage during actual operation has a small affect. In this regard, according to the above-described configuration, when the neuron coverage is the second value less than the first value, the increase in width is set to the second increase in width greater than the first increase in width. Thus, the threshold value for the acceptability determination of the second index can be set to a more appropriate value.

In some embodiments, the evaluating unit 153 evaluates reliability as being high when the first index is less than the first threshold value and the second index is less than the second threshold value, and evaluates reliability as being low when the first index is equal to or greater than the first threshold value and the second index is equal to or greater than the second threshold value.

In some embodiments, the evaluating unit 153 is configured to evaluate the prediction error of the learning model in a case where the first index is less than the first threshold value and the second index is equal to or greater than the second threshold value, or in a case where the first index is equal to or greater than the first threshold value and the second index is less than the second threshold value.

In the evaluation of the prediction error, both the prediction value and a correct value are required. In the case of a learning model that predicts the future, a wait time until the correct value is acquired is required. Note that, as opposed to a learning model that predicts the future, such a problem does not arise in a learning model that predicts the prediction value of the output at the same time as the input data. Note that in a case where the index and the threshold value come to the same value, it may be configured to determine the index as being the larger or to determine the index as being the smaller. That is, the magnitude relationship may be determined on the basis of being equal to or greater than a threshold value or not or being equal to or less than a threshold value or not.

In some embodiments, the evaluating unit 153 is configured to change the calculation formula for the first index such that the first index is decreased when the first index is equal to or greater than the first threshold value, the second index is less than the second threshold value, and the prediction error of the learning model is less than a reference value. The calculation formula includes two or more variables (for example, two or more measurements). In changing the calculation formula, for example, the weighting in the calculation formula may be changed, the variables in the calculation formula may be increased or decreased (change in dimensions), the coefficient of dropout in the calculation formula may be increased or decreased, and the like.

In some embodiments, the evaluating unit 153 is configured to adjust the structure of the neural network such that the second index is increased when the first index is equal to or greater than the first threshold value, the second index is less than the second threshold value, and the prediction error of the learning model is equal to or greater than a reference value. For example, in a case where the neuron coverage when learning is too large, the evaluating unit 153 performs adjustment such that the number of neurons (i.e., denominator) is increased and the neuron coverage when learning is decreased. Note that by reducing the number of neurons that have ignited in learning (i.e., the numerator), the neuron coverage in learning may be adjusted and decreased. This increases the second index.

In some embodiments, the evaluating unit 153 is configured to change the calculation formula for the first index such that the first index is increased when the first index is less than the first threshold value, the second index is equal to or greater than the second threshold value, and the prediction error of the learning model is equal to or greater than a reference value.

In some embodiments, the evaluating unit 153 is configured to adjust the structure of the neural network such that the second index is decreased when the first index is less than the first threshold value, the second index is equal to or greater than the second threshold value, and the prediction error of the learning model is less than a reference value. For example, in a case where the neuron coverage when learning is too small, the evaluating unit 153 performs adjustment such that the number of neurons (i.e., denominator) is decreased and the neuron coverage when learning is increased. This decreases the second index.

In some embodiments, the evaluating unit 153 is configured to execute re-learning or execute output of a notification prompting for re-learning in one or more of: a case where the first index is equal to or greater than the first threshold value and the second index is equal to or greater than the second threshold value, a case where the first index is equal to or greater than the first threshold value, the second index is less than the second threshold value, and the prediction error of the learning model is evaluated to be equal to or greater than a reference value, or a case where the first index is less than the first threshold value, the second index is equal to or greater than the second threshold value, and the prediction error of the learning model is equal to or greater than a reference value. Since there may be rare cases where the frequency is extremely small (i.e., noise), in a case where a plurality of similar actual operation input data is gathered, the evaluating unit 153 may perform the re-learning using the data and corresponding correct value.

Note that the evaluating unit 153 may be configured to execute the evaluation only, and a user executes the determination of whether or not to execute re-learning and executes re-learning. In other words, the evaluating unit 153 is not limited to a configuration in which it executes all of the above-described processes.

### Process Flow

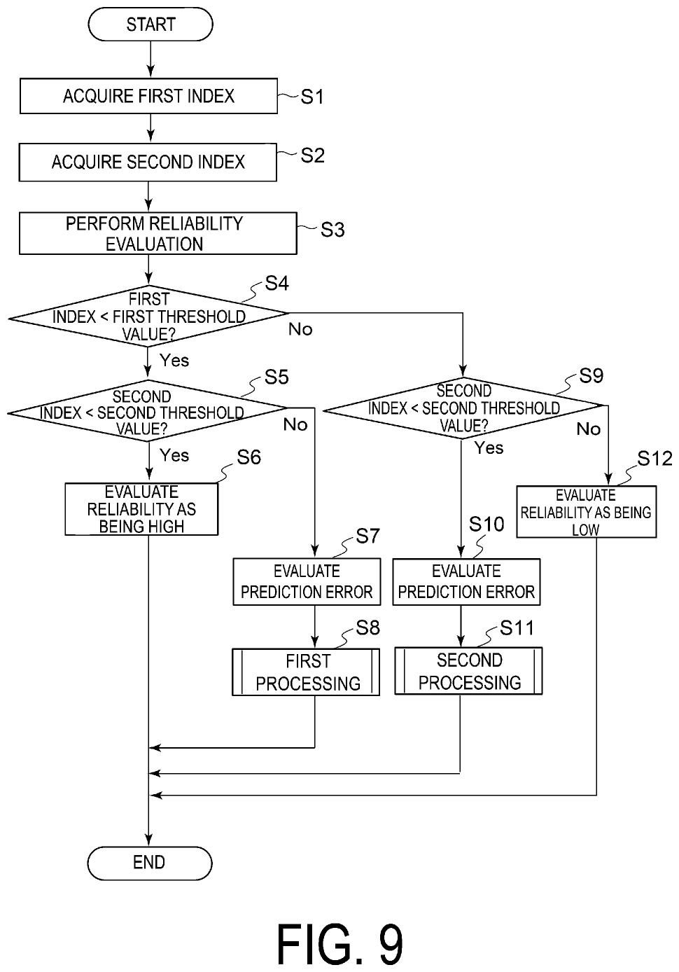

The flow of the processing executed by the evaluating device 100 according to an embodiment is described below. FIG. 9 is a flowchart for describing an example of the processing executed by the evaluating device 100 according to an embodiment. Here, an example of the processing after the learning model has already been trained based on the learning input data will now be described.

The evaluating device 100 acquires the first index indicating the difference between the learning input data and the actual operation input data in the data space (step S1). The evaluating device 100 acquires the second index indicating the difference in the ignition tendency of the neurons between the time of input of the learning input data in the learning model of the neural network and the time of input of the actual operation input data in the learning model of the neural network (step S2). The evaluating device 100 executes evaluation of the reliability of the prediction value output from the learning model with respect to the actual operation input data on the basis of the first index and the second index (step S3).

Here, the evaluating device 100 determines whether or not the first index is less than the first threshold value (step S4). In a case where the first index is determined to be less than the first threshold value (Yes in step S4), the evaluating device 100 determines whether or not the second index is less than the second threshold value (step S5). In a case where the second index is determined to be less than the second threshold value (Yes in step S5), the evaluating device 100 evaluates the reliability as being high (step S6).

In a case where the second index is determined to be equal to or greater than the second threshold value (No in step S5), the evaluating device 100 evaluates the prediction error of the learning model (step S7). At this time, the evaluating device 100 may evaluate the reliability as being medium or unknown. Next, the evaluating device 100 executes a first processing (step S8).

In the first processing, in a case where the prediction error is evaluated to be less than a reference value, the evaluating device 100 adjusts the structure of the neural network such that the second index is decreased. In the first processing, in a case where the prediction error is evaluated to be equal to or greater than a reference value, the evaluating device 100 changes the calculation formula of the first index such that the first index is increased. In this case, the re-learning may be executed after the change.

In a case where the first index is determined to be equal to or greater than the first threshold value (No in step S4), the evaluating device 100 determines whether or not the second index is less than the second threshold value (step S9). In a case where the second index is determined to be less than the second threshold value (Yes in step S9), the evaluating device 100 evaluates the prediction error of the learning model (step S10). At this time, the evaluating device 100 may evaluate the reliability as being medium or unknown. Next, the evaluating device 100 executes a second processing (step S11).

In the second processing, in a case where the prediction error of the learning model is evaluated to be less than a reference value, the evaluating device 100 changes the calculation formula of the first index such that the first index is decreased. In the second processing, in a case where the prediction error of the learning model is evaluated to be equal to or greater than a reference value, the evaluating device 100 adjusts the structure of the neural network such that the second index is increased. In this case, the re-learning may be executed after the adjustment.

In a case where the second index is determined to be equal to or greater than the second threshold value (No in step S9), the evaluating device 100 evaluates the reliability as being low (step S12). In this case, the re-learning may be executed after the evaluation.

The flow of the processing executed by the evaluating device 100 is not limited to the example illustrated in FIG. 9. For example, evaluation of the prediction error may take time corresponding to a wait time until a correct value is obtained. As a result, processing such as evaluation of the prediction error, the first processing, and the second processing may be omitted, and the processing may end at a stage where the evaluation of reliability (determination of high, medium, low, or the like) has finished. In FIG. 9, a comparison between the first index and the first threshold value (step S4) is performed, and then the second index and the second threshold value are compared (steps S5 and S9), but the order may be reversed. The order of steps S1 and S2 may also be reversed. In this way, the flow of processing can be changed as appropriate within a range that allows the various functions to be implemented overall. Furthermore, part of the processing executed by the evaluating device 100 may be changed to be performed manually rather than automatically.

### Configuration of Plant Control Assist System

A plant control assist system 700 will now be described as an example of the use of the evaluating device 100. Note that the evaluating device 100 may be used to assist in controlling the fuel flow rate and the degree of opening of the valve for a gas turbine or a steam turbine, rather than being used to assist in controlling the plant 400. The plant 400 may be a chemical plant or another type of plant. That is, the evaluating device 100 is applicable to a system that performs control using a prediction value of the learning model.

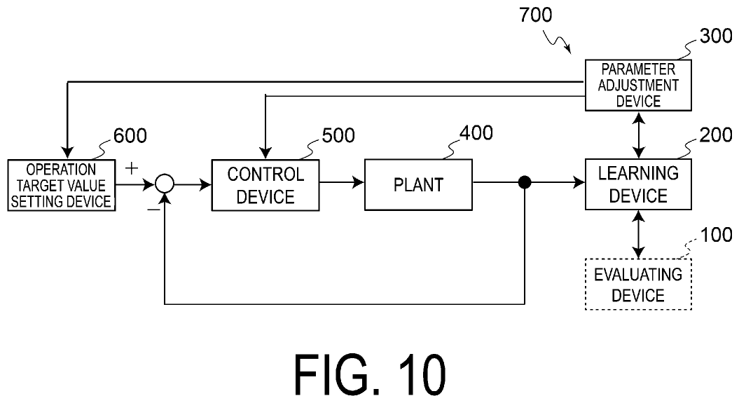

FIG. 10 is a block diagram schematically illustrating the configuration of the plant control assist system 700 according to an embodiment. The plant control assist system 700 includes a learning device 200 including a learning model for predicting the state of the plant 400, and a parameter adjustment device 300 configured to adjust a setting parameter and/or an operation target value of a control device 500 of the plant 400 in response to the prediction result of the learning model. The operation target value of the control device 500 is set by an operation target value setting device 600. The learning device 200 is configured to perform re-learning of the learning model in accordance with the evaluation result of the evaluating device 100.

In the normal control of the plant 400, a user views the state of the plant 400 with respect to the control device 500, and performs the parameter adjustment and sets the operation target value. In the present embodiment, the parameter adjustment device 300 and the operation target value setting device 600 automate such manual settings. The learning device 200 includes a learning model that simulates the state of the plant 400 and is configured to output a prediction value with respect to the input data. The learning model of the learning device 200 performs learning based on learning input data obtained offline. The evaluating device 100 evaluates the reliability of the prediction value output by the learning model based on the actual operation input data during actual operation.

The evaluating device 100 may acquire learning input data and actual operation input data from the learning device 200 or a database (not illustrated) that stores previous performance values. As a result, the evaluating device 100 can acquire the first index.

The evaluating device 100 may acquire information relating to the structure of the neural network of the learning model from the learning device 200 or information relating to the ignition of the neurons. As a result, the evaluating device 100 can acquire the second index.

The evaluating device 100 may perform evaluation on the basis of the first index and the second index, and transmit the evaluation results to the learning device 200. Furthermore, the evaluating device 100 may transmit an instruction relating to re-learning or adjusting the neuron structure to the learning device 200. The learning device 200 communicates with the parameter adjustment device 300 on the basis of the information received from the evaluating device 100, and the parameter adjustment device 300 reflects the information received from the evaluating device 100 in the parameter adjustment and the operation target value. According to such a configuration, the results of evaluation of the reliability of the prediction value output from the learning model with respect to the actual operation input data can be used to assist in control.

The present disclosure is not limited to the embodiments described above and also includes a modification of the above-described embodiments as well as appropriate combinations of embodiments.

### SUMMARY

The details described in each embodiment can be understood as follows, for example.

(1) An evaluating device (100) according to the present disclosure includes:

a first acquisition unit (151) configured to acquire a first index indicating a difference in data space between learning input data and actual operation input data;

a second acquisition unit (152) configured to acquire a second index indicating a difference in ignition tendency of neurons between a case when the learning input data is input in a learning model of a neural network and a case when the actual operation input data is input in the learning model of the neural network; and

an evaluating unit (153) configured to evaluate a reliability of a prediction value output from the learning model with respect to the actual operation input data based on the first index and the second index.

According to the above-described configuration, reliability of the prediction value output from the learning model of the neural network with respect to the actual operation input data is evaluated on the basis of the first index indicating the difference in the data space and the second index indicating the difference in the ignition tendency of the neurons. This improves the evaluation accuracy.

(2) In some embodiments, in the configuration according to (1) described above,

the evaluating unit (153) evaluates the reliability as being high when the first index is less than a first threshold value and the second index is less than a second threshold value, and evaluates the reliability as being low when the first index is equal to or greater than the first threshold value and the second index is equal to or greater than the second threshold value.

According to the above-described configuration, it is possible to easily evaluate whether or not the reliability is high. It is also possible to determine the need for re-learning based on the evaluation results.

Note that when the reliability of the prediction value output from the learning model that outputs the future prediction value is evaluated based on the prediction error (difference between the prediction value and the correct value), a wait time occurs. For example, after a prediction value for after two weeks is obtained, a wait time of two weeks occurs until the correct value is obtained. In this regard, according to the above-described configuration, reliability can be evaluated without acquiring the correct value, and therefore the reliability can be evaluated in a shorter time compared to the evaluation of the prediction error.

(3) In some embodiments, in the configuration according to (1) or (2) described above,

the evaluating unit (153) evaluates a prediction error of the learning model in a case where the first index is less than a first threshold value and the second index is equal to or greater than a second threshold value, or in a case where the first index is equal to or greater than the first threshold value and the second index is less than the second threshold value.

In a case where only one of the first index and the second index is less than the threshold value, reliability may be unable to be determined. In this regard, according to the above-described configuration, in order to evaluate the prediction error in such a case, it is possible to make a correspondence based on the evaluation result of the prediction error. For example, based on the evaluation result of the prediction error, it is possible to evaluate the reliability, review the evaluation method using the first index and the second index, and the like.

(4) In some embodiments, in the configuration according to (3) described above,

the evaluating unit changes a calculation formula for the first index such that the first index is decreased when the first index is equal to or greater than the first threshold value, the second index is less than the second threshold value, and the prediction error is evaluated as being less than a reference value.

According to the above-described configuration, as a result of the calculation formula of the first index being changed, when the prediction error is small, both the first index and the second index can be more likely to be less than the threshold value. As a result, gray zones that make it difficult to determine whether the reliability is high can be reduced.

(5) In some embodiments, in the configuration according to (3) or (4) described above,

the evaluating unit (153) adjusts a structure of the neural network such that the second index is increased when the first index is equal to or greater than the first threshold value, the second index is less than the second threshold value, and the prediction error is evaluated as being equal to or greater than a reference value.

According to the above-described configuration, as a result of the structure of the neural network being adjusted, when the prediction error is large, both the first index and the second index can be more likely to be greater than the threshold value. As a result, gray zones that make it difficult to determine whether the reliability is high can be reduced.

(6) In some embodiments, in the configuration according to any one of (3) to (5) described above,

the evaluating unit (153) changes a calculation formula for the first index such that the first index is increased when the first index is less than the first threshold value, the second index is equal to or greater than the second threshold value, and the prediction error is evaluated as being equal to or greater than a reference value.

According to the above-described configuration, as a result of the calculation formula of the first index being changed, when the prediction error is large, both the first index and the second index can be more likely to be equal to or greater than the threshold value. As a result, gray zones that make it difficult to determine whether the reliability is high can be reduced.

(7) In some embodiments, in the configuration according to any one of (3) to (6) described above,

the evaluating unit (153) adjusts a structure of the neural network such that the second index is decreased when the first index is less than the first threshold value, the second index is equal to or greater than the second threshold value, and the prediction error is evaluated as being less than a reference value.

According to the above-described configuration, as a result of the structure of the neural network being adjusted, when the prediction error is small, both the first index and the second index can be more likely to be less than the threshold value. As a result, gray zones that make it difficult to determine whether the reliability is high can be reduced.

(8) In some embodiments, in the configuration according to any one of (1) to (7) described above,

the evaluating unit (153) is configured to execute re-learning or executes output of a notification prompting for re-learning in one or more of:

a case where the first index is equal to or greater than a first threshold value and the second index is equal to or greater than a second threshold value, a case where the first index is equal to or greater than the first threshold value, the second index is less than the second threshold value, and a prediction error of the learning model is evaluated as being equal to or greater than a reference value, or

a case where the first index is less than the first threshold value, the second index is equal to or greater than the second threshold value, and the prediction error is evaluated as being equal to or greater than the reference value.

According to the above-described configuration, because re-learning is executed or a notification is outputted prompting for re-learning in a case where the reliability of the learning model is low, the reliability of the prediction value output from the learning model can be ensured.

(9) In some embodiments, in the configuration according to any one of (1) to (8) described above,

the second acquisition unit (152) is configured to calculate the second index based on a neuron coverage indicating a degree of ignition of all of the plurality of neurons included in the neural network.

According to the above-described configuration, the second index can be calculated using a simple process compared to other calculation methods.

(10) In some embodiments, in the configuration according to any one of (1) to (9) described above,

the second acquisition unit (152) is configured to calculate the second index based on one or more of:

a degree of ignition in each of the plurality of neurons included in the neural network,

a degree of ignition of the neurons in a layer of the neural network including a plurality of layers, or

a degree of diversity of ignition patterns of the plurality of neurons.

According to the above-described configuration, it is possible to realize an evaluation suitable for the structure of the learning model of the neural network.

(11) In some embodiments, in the configuration according to any one of (1) to (10) described above,

the second acquisition unit (152) is configured to calculate the second index based on a difference in neuron coverage indicating a degree of ignition of all of the plurality of neurons and a difference in ignition patterns of the plurality of neurons.

According to the above-described configuration, it is possible to improve the evaluation accuracy because the differences in the ignition patterns of the neurons are reflected in the second index, as well as differences between the neuron coverage in a case of learning and the neuron coverage in a case of actual operation.

(12) In some embodiments, in the configuration according to any one of (1) to (11) described above,

the second acquisition unit (152) is configured to calculate the second index based on a difference in an ignition frequency of each of the plurality of neurons.

According to the configuration described above, the difference in the ignition frequency of neurons in learning and in actual operation is also evaluated, which is advantageous in cases where a decrease in the prediction accuracy due to a large change in the ignition frequency of the neurons can occur.

(13) In some embodiments, in the configuration according to any one of (1) to (12) described above,

the first acquisition unit (151) is configured to calculate the first index based on an Euclidean distance in the data space between the learning input data and the actual operation input data.

According to the above-described configuration, the first index can be calculated using a simple process compared to other calculation methods.

(14) In some embodiments, in the configuration according to any one of (1) to (13) described above,

the learning input data and the actual operation input data each include a plurality of types of input data, and

the first acquisition unit (151) is configured to calculate the first index by adding weighting based on a degree of importance to each type of the input data of the learning input data and the actual operation input data.

According to the above-described configuration, the first index in which is reflected the degree of importance of the input data is used, so the evaluation accuracy can be improved. In addition, it is advantageous that the input data can be evaluated in a centralized manner even in cases where there are many types of input data.

(15) In some embodiments, in the configuration according to any one of (1) to (14) described above,

the first acquisition unit (151) is configured to use a dropout method to represent a distribution of output values in a case where the learning input data is input and calculate the first index based on a variance value in a case where the actual operation input data is input in the distribution.

According to the above-described configuration, the first index calculated using the distribution of the output values is used, so any bias in the evaluation can be suppressed.

(16) In some embodiments, in the configuration according to any one of (1) to (14) described above,

the evaluating unit (153) is configured to determine a center value of a distribution in the data space of the learning input data, set a deviation or variance value from the center value as the first threshold value for acceptability determination of the first index, and evaluate the reliability.

According to the above-described configuration, the acceptability determination of the first index can be simplified by using the threshold value to make an acceptability determination of the first index.

(17) In some embodiments, in the configuration according to any one of (1) to (16) described above,

the evaluating unit (153) is configured to evaluate the reliability with a second threshold value for acceptability determination of the second index being an increase in width corresponding to a neuron coverage in a case where the learning input data is input.

According to the above-described configuration, the acceptability determination of the second index can be simplified by using the threshold value to make an acceptability determination of the second index.

(18) A plant control assist system (700) according to the present disclosure includes:

a learning device (200) including a learning model for predicting a state of a plant (400); and

a parameter adjustment device (300) configured to adjust a setting parameter and/or an operation target value of a control device (500) of the plant (400) according to a prediction result of the learning model,

the learning device (200) being configured to execute re-learning of the learning model according to an evaluation result of the evaluating device (100) according to any one of (1) to (17) described above.

According to the above-described configuration, the learning device (200) performs re-learning on the basis of the evaluation results of the evaluating device (100). As a result, adjustment of the setting parameters and/or the operation target values corresponding to the prediction results of the learning model can be optimized.

(19) An evaluation method according to the present disclosure includes:

acquiring a first index indicating a difference in data space between learning input data and actual operation input data;

acquiring a second index indicating a difference in ignition tendency of neurons between a case when the learning input data is input in a learning model of a neural network and a case when the actual operation input data is input in the learning model of the neural network; and

evaluating a reliability of a prediction value output from the learning model with respect to the actual operation input data based on the first index and the second index.

According to the above-described method, it is possible to improve the evaluation accuracy when evaluating the reliability of the prediction value output from the learning model of the neural network.

(20) A program according to the present disclosure causes a computer to execute:

acquiring a first index indicating a difference in data space between learning input data and actual operation input data;

acquiring a second index indicating a difference in ignition tendency of neurons between a case when the learning input data is input in a learning model of a neural network and a case when the actual operation input data is input in the learning model of the neural network; and

evaluating a reliability of a prediction value output from the learning model with respect to the actual operation input data based on the first index and the second index.

According to the program described above, evaluation accuracy when evaluating the reliability of the prediction value output from the learning model of the neural network can be improved.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An evaluating device, comprising:
a first acquisition unit configured to acquire a first index indicating a difference in data space between learning input data and actual operation input data;
a second acquisition unit configured to acquire a second index indicating a difference in ignition tendency of neurons between a case when the learning input data is input in a learning model of a neural network and a case when the actual operation input data is input in the learning model of the neural network; and
an evaluating unit configured to evaluate a reliability of a prediction value output from the learning model with respect to the actual operation input data based on the first index and the second index.

2. The evaluating device according to claim 1, wherein
the evaluating unit evaluates the reliability as being high when the first index is less than a first threshold value and the second index is less than a second threshold value, and evaluates the reliability as being low when the first index is equal to or greater than the first threshold value and the second index is equal to or greater than the second threshold value.

3. The evaluating device according to claim 1, wherein
the evaluating unit evaluates a prediction error of the learning model in a case where the first index is less than a first threshold value and the second index is equal to or greater than a second threshold value, or in a case where the first index is equal to or greater than the first threshold value and the second index is less than the second threshold value.

4. The evaluating device according to claim 3, wherein
the evaluating unit changes a calculation formula for the first index such that the first index is decreased when the first index is equal to or greater than the first threshold value, the second index is less than the second threshold value, and the prediction error is evaluated as being less than a reference value.

5. The evaluating device according to claim 3, wherein
the evaluating unit adjusts a structure of the neural network such that the second index is increased when the first index is equal to or greater than the first threshold value, the second index is less than the second threshold value, and the prediction error is evaluated as being equal to or greater than a reference value.

6. The evaluating device according to claim 3, wherein
the evaluating unit changes a calculation formula for the first index such that the first index is increased when the first index is less than the first threshold value, the second index is equal to or greater than the second threshold value, and the prediction error is evaluated as being equal to or greater than a reference value.

7. The evaluating device according to claim 3, wherein
the evaluating unit adjusts a structure of the neural network such that the second index is decreased when the first index is less than the first threshold value, the second index is equal to or greater than the second threshold value, and the prediction error is evaluated as being less than a reference value.

8. The evaluating device according to claim 1, wherein
the evaluating unit is configured to execute re-learning or executes output of a notification prompting for re-learning in one or more of:
a case where the first index is equal to or greater than a first threshold value and the second index is equal to or greater than a second threshold value,
a case where the first index is equal to or greater than the first threshold value, the second index is less than the second threshold value, and a prediction error of the learning model is evaluated as being equal to or greater than a reference value, or
a case where the first index is less than the first threshold value, the second index is equal to or greater than the second threshold value, and the prediction error is evaluated as being equal to or greater than the reference value.

9. The evaluating device according to claim 1, wherein
the second acquisition unit is configured to calculate the second index based on a neuron coverage indicating a degree of ignition of all of the plurality of neurons included in the neural network.

10. The evaluating device according to claim 1, wherein
the second acquisition unit is configured to calculate the second index based on one or more of:
a degree of ignition in each of the plurality of neurons included in the neural network,
a degree of ignition of the neurons in a layer of the neural network including a plurality of layers, or
a degree of diversity of ignition patterns of the plurality of neurons.

11. The evaluating device according to claim 1, wherein
the second acquisition unit is configured to calculate the second index based on a difference in neuron coverage indicating a degree of ignition of all of the plurality of neurons and a difference in ignition patterns of the plurality of neurons.

12. The evaluating device according to claim 1, wherein
the second acquisition unit is configured to calculate the second index based on a difference in an ignition frequency of each of the plurality of neurons.

13. The evaluating device according to claim 1, wherein
the first acquisition unit is configured to calculate the first index based on an Euclidean distance in the data space between the learning input data and the actual operation input data.

14. The evaluating device according to claim 1, wherein
the learning input data and the actual operation input data each include a plurality of types of input data, and
the first acquisition unit is configured to calculate the first index by adding weighting based on a degree of importance to each type of the input data of the learning input data and the actual operation input data.

15. The evaluating device according to claim 1, wherein
the first acquisition unit is configured to use a dropout method to represent a distribution of output values in a case where the learning input data is input and calculate the first index based on a variance value in a case where the actual operation input data is input in the distribution.

16. The evaluating device according to claim 1, wherein
the evaluating unit is configured to determine a center value of a distribution in the data space of the learning input data, set a deviation or variance value from the center value as the first threshold value for acceptability determination of the first index, and evaluate the reliability.

17. The evaluating device according to claim 1, wherein
the evaluating unit is configured to evaluate the reliability with a second threshold value for acceptability determination of the second index being an increase in width corresponding to a neuron coverage in a case where the learning input data is input.

18. A plant control assist system, comprising:
a learning device including a learning model for predicting a state of a plant; and
a parameter adjustment device configured to adjust a setting parameter and/or an operation target value of a control device of the plant according to a prediction result of the learning model,
the learning device being configured to execute re-learning of the learning model according to an evaluation result of the evaluating device described in claim 1.

19. An evaluation method, comprising:
acquiring a first index indicating a difference in data space between learning input data and actual operation input data;
acquiring a second index indicating a difference in ignition tendency of neurons between a case when the learning input data is input in a learning model of a neural network and a case when the actual operation input data is input in the learning model of the neural network; and
evaluating a reliability of a prediction value output from the learning model with respect to the actual operation input data based on the first index and the second index.

20. A non-transitory computer readable recording medium storing a program for causing a computer to execute:
acquiring a first index indicating a difference in data space between learning input data and actual operation input data;
acquiring a second index indicating a difference in ignition tendency of neurons between a case when the learning input data is input in a learning model of a neural network and a case when the actual operation input data is input in the learning model of the neural network; and
evaluating a reliability of a prediction value output from the learning model with respect to the actual operation input data based on the first index and the second index.
